(19) United States
(12) Patent Application Publication
(10) Pub. No.: US 2009/0113695 A1
(43) Pub. Date: May 7, 2009

(54) METHOD FOR MANUFACTURING METALLIC KEYPAD HAVING RIPPLE LUSTER

(76) Inventors: Che-Tung Wu, Gueishan (TW); Chih-Ho Hsu, Gueishan (TW); Kai-Jie Taso, Gueishan (TW)

Correspondence Address: HDLS Patent & Trademark Services, P.O. BOX 220746, CHANTILLY, VA, 20153-0746, US

(21) Appl. No.: 11/946,446

(22) Filed: Nov. 28, 2007

(30) Foreign Application Priority Data
Nov. 7, 2007 (TW) 096142045

(51) Int. Cl. B23P 15/00

(52) U.S. Cl. 29/592.1

(57) ABSTRACT

A method for manufacturing a metallic keypad has a ripple luster. First, a metallic thin plate is prepared. The metallic thin plate is subjected to an etching process, thereby forming a plurality of hollowed portions on the metallic thin plate. The hollowed portions are used to define a pressing region for the key and icons for the surface of the pressing region. The metallic thin plate is cut to form a metallic keypad having a predetermined shape. Then, after an electroplated layer is coated on the surface of the metallic keypad, a layer of protective film is adhered on the non-electroplated surface of the metallic keypad. Finally, the metallic keypad is disposed into a mold. A plastic material is injected into the mold, so that the plastic material forms a pattern layer. Finally, an adhesive layer is applied on the non-electroplated surface of the metallic keypad. The elastic layer having a plurality of protrusions is adhered on the surface of the adhesive layer. Via the above steps, the metallic keypad having a ripple luster is manufactured completely.

### BACKGROUND OF THE INVENTION

1. Field of the Invention

The present invention relates to a keypad, and in particular to a method for manufacturing a metallic keypad.

2. Description of Prior Art

Keypad panel has become a necessary hardware for an electronic device. The surface of the keypad panel is provided with numerals, characters, phonetic symbols, roots for an input method and various functional icons, so that a user can input data or perform various functions of the electronic device. Therefore, for a handheld electronic device, the keypad panel is a very important input means.

For example, a conventional metallic keypad on an electronic device is shown in FIGS. 1(a) to 1(f) (Japanese Laid-Open Patent Publication No. 2007-134071). In manufacturing the metallic keypad 10a disclosed in FIG. 1, a metallic plate 1a is prepared first, and the metallic plate 1a is attached on a transparent plastic film 2a. Then, the metallic plate 1a is made to have a hollowed portion 3a. The surface of the metallic plate 1a is formed with a transparent resin layer 4a. The bottom surface of the transparent plastic film 2a is formed with a transparent elastic layer 5a. In manufacturing the transparent elastic layer 5a, via a hot pressing process, the transparent plastic film 2a and the transparent elastic layer 5a are compressed into the hollowed portion 3a together, thereby forming a separating line 21a for separating the metallic keypads. Then, a light-emitting layer 6a is attached to the bottom of the transparent elastic layer 5a.

In manufacturing the above metallic keypad 10a, since the transparent plastic film 2a and the transparent elastic layer 5a are compressed into the hollowed portion 3a together, the pressing force and the heating temperature should be properly controlled during the hot pressing process. Otherwise, the transparent plastic film 2a and the transparent elastic layer 5a cannot be compressed into the hollowed portion 3a completely, causing defective products. Even, during the process of compressing the transparent plastic film 2a and the transparent elastic layer 5a into the hollowed portion 3a, the transparent plastic film 2a may rub and pull the wall faces and chamfers of the hollowed portion 3a, causing the breakage of the transparent plastic film 2a easily and the difficulty in manufacture.

Next, gaps are generated easily between the transparent plastic film 2a compressed into the hollowed portion 3a and the wall face of the hollowed portion 3a. The gaps may be filled by dusts or penetrated by liquid, so that the metallic keypads cannot be pressed smoothly or an internal short circuit may occur.

Further, the surface of the transparent resin layer 4a formed on the metallic plate 1a is a flat surface, which merely provides a protective effect for the metallic plate 1a without any reflective effect of a particular luster. Therefore, the external appearance and the overall visual effect of the metallic keypad 10a are dull.

### SUMMARY OF THE INVENTION

In view of the above drawbacks, the present invention is to provide a novel and simple method for manufacturing a metallic keypad that allows the metallic keypads to be manufactured easily and be pressed smoothly. Further, it also makes the surface of the metallic keypad to have a reflective effect of a ripple luster.

The present invention is to provide a method for manufacturing a metallic keypad having a ripple luster. First, a metallic thin plate is prepared. The metallic thin plate is subjected to an etching process, thereby forming a plurality of hollowed portions on the metallic thin plate. The hollowed portions are used to define a pressing region for the key and icons for the surface of the pressing region. After cutting the etched metallic thin plate having the hollowed portions, a metallic keypad having a predetermined shape is formed. Then, the completely cut metallic keypad is subjected to an electroplating process in an electroplating tank, thereby coating an electroplated layer on the surface of the metallic keypad. After the electroplating of the metallic keypad is completed, a layer of protective film is adhered on the non-electroplated surface of the metallic keypad. Finally, the metallic keypad adhered with the protective film is disposed into a mold. A plastic material such as TPU or TPE is injected into the mold, so that the plastic material can be attached on the surface of the electroplated layer and the hollowed portion. Further, the pattern in the inner surface of the mold forms a pattern layer on the plastic material. After the protective film on the other surface of the metallic keypad is peeled off, an adhesive layer is applied on the non-electroplated surface of the metallic keypad. The elastic layer having the plurality of protrusions is adhered on the surface of the adhesive layer. Via the above steps, the manufacturing of the metallic keypad is completed.

### BRIEF DESCRIPTION OF THE DRAWINGS

FIGS. 1(a) to 1(f) are structural views showing a procedure for manufacturing a traditional metallic keypad;

FIG. 2 is a schematic view showing the procedure for manufacturing a metallic keypad of the present invention;

FIGS. 3(a) to 3(k) are structural views showing the procedure for manufacturing a metallic keypad of the present invention;

FIG. 4 is a schematic view showing the metallic keypad of the present invention being used in a mobile phone;

FIG. 5 is a schematic view showing the metallic keypad of the present invention being used in a personal digital assistant (PDA); and

FIG. 6 is a schematic view showing the metallic keypad of the present invention being used in an automobile stereo panel.

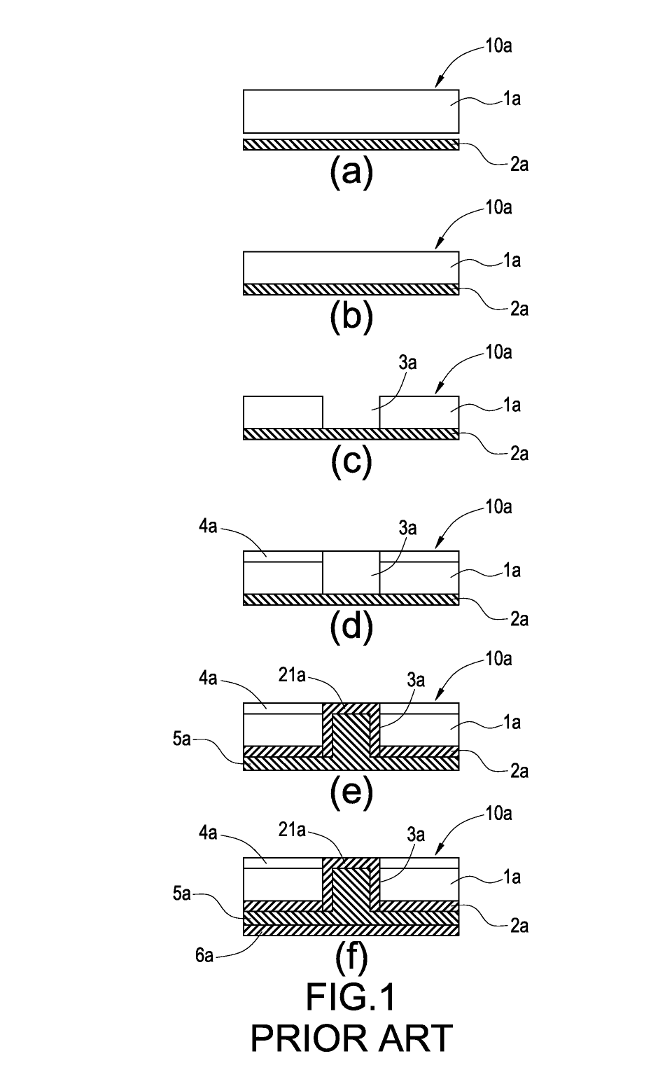

### DETAILED DESCRIPTION OF THE INVENTION

The detailed description and the technical contents of the present invention will be explained with reference to the accompanying drawings.

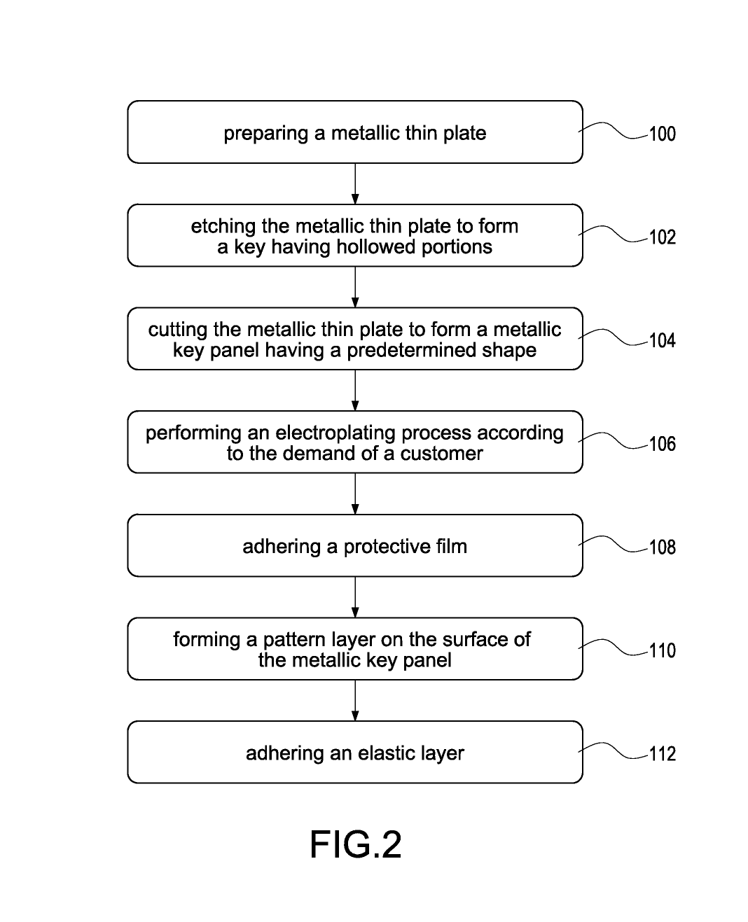

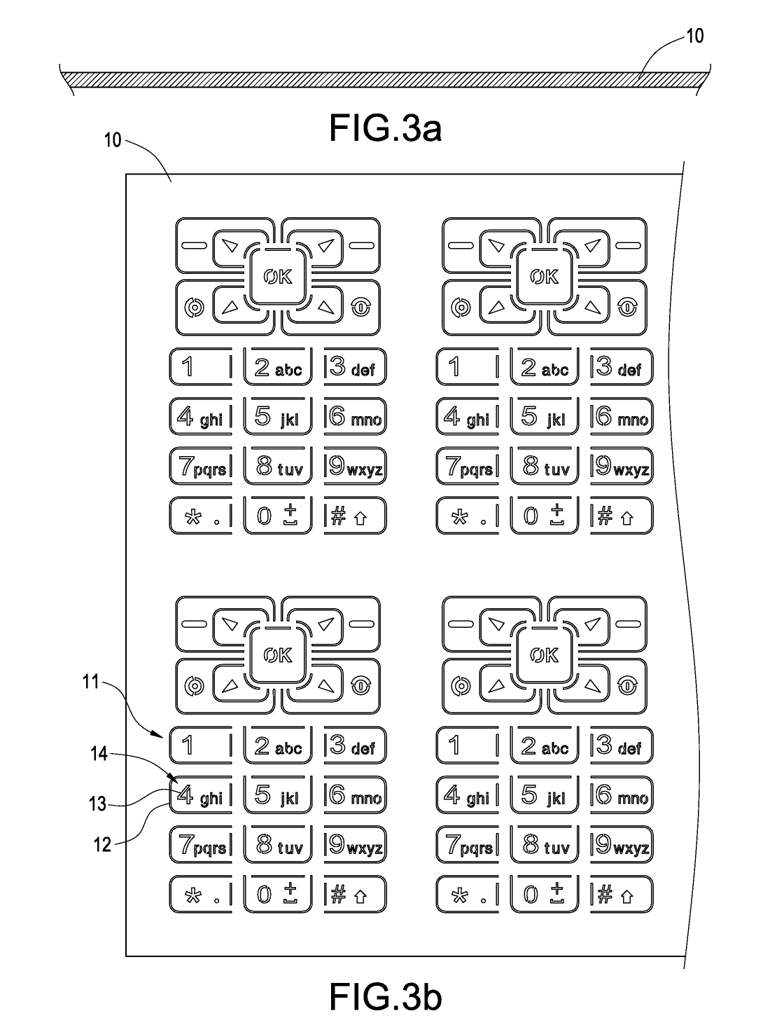

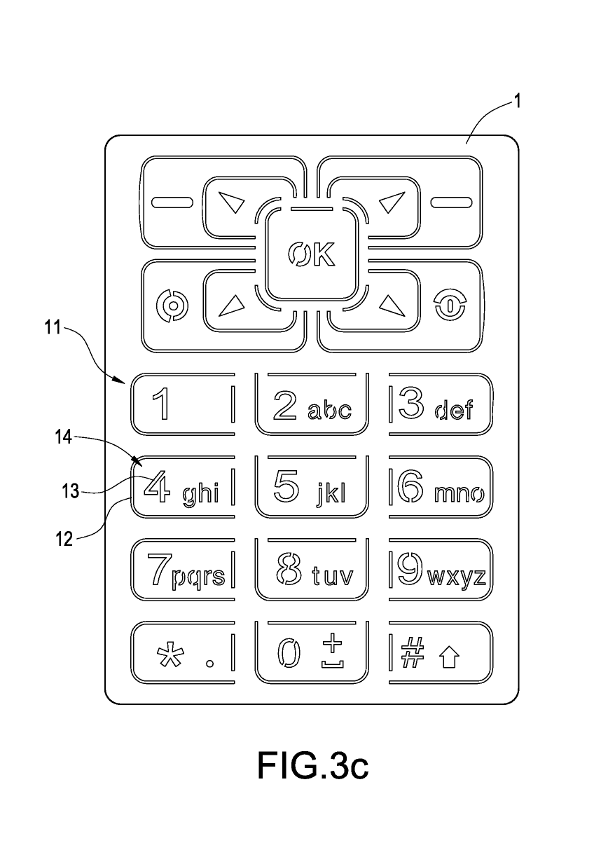

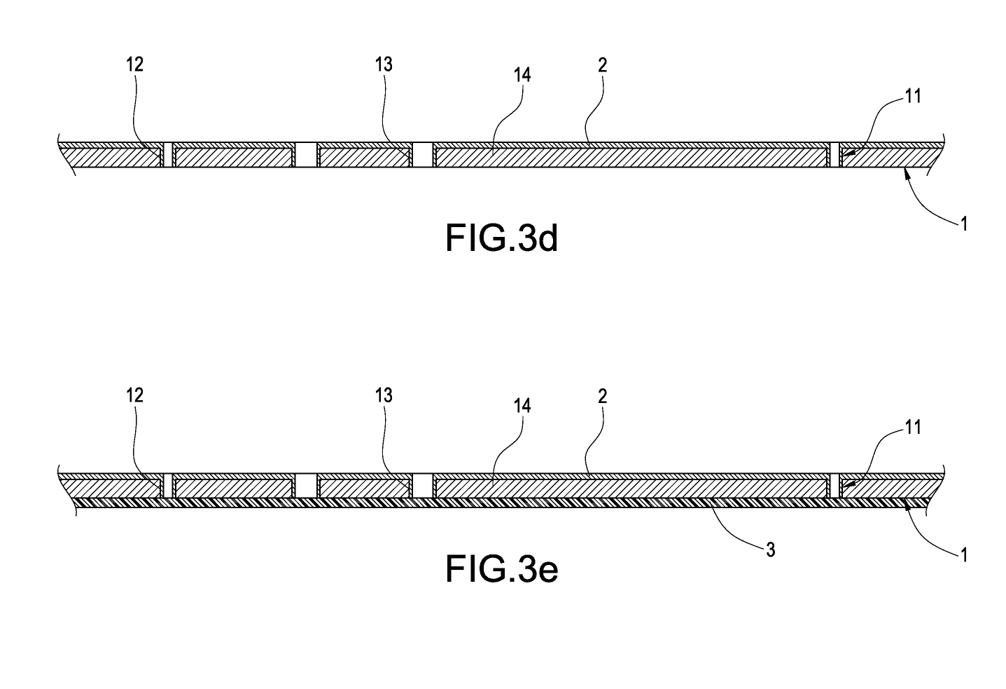

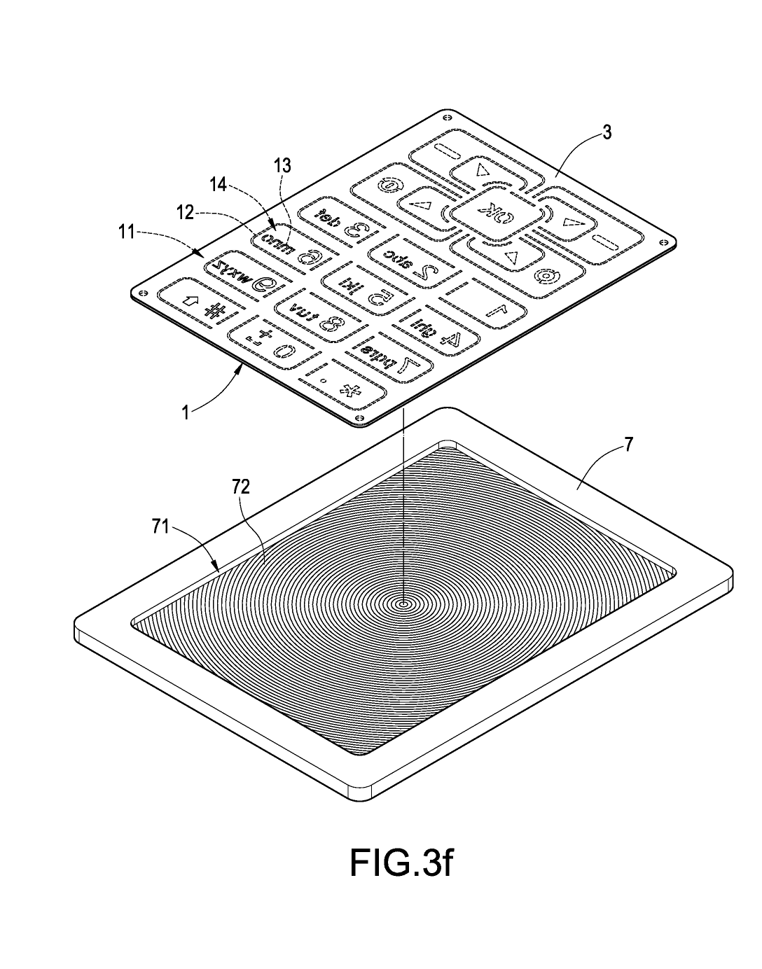

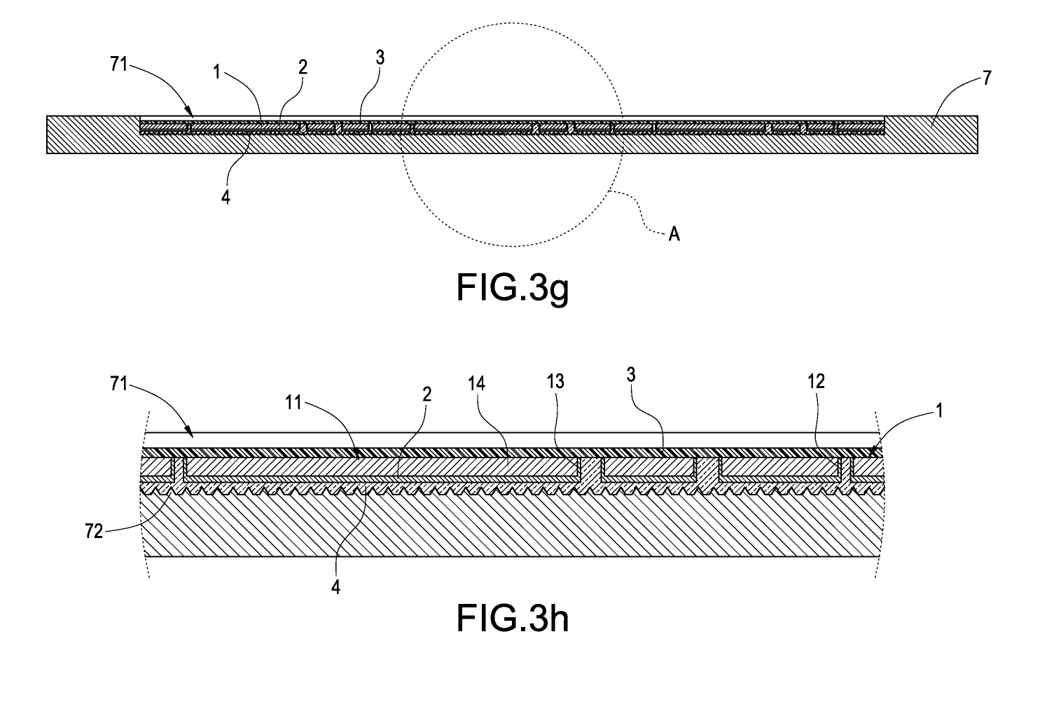

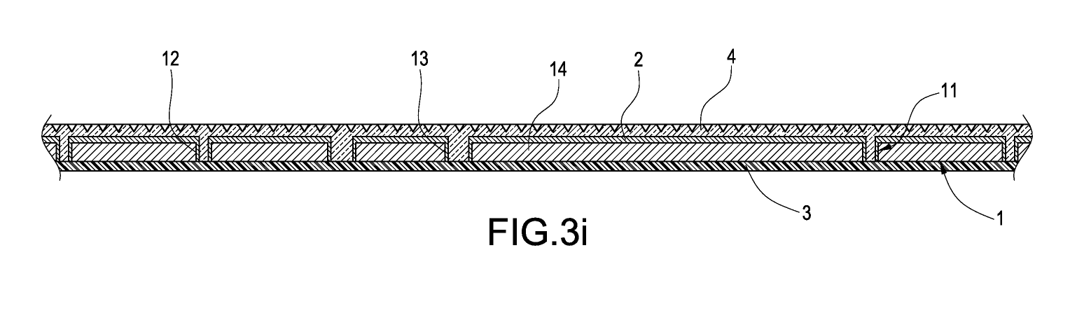

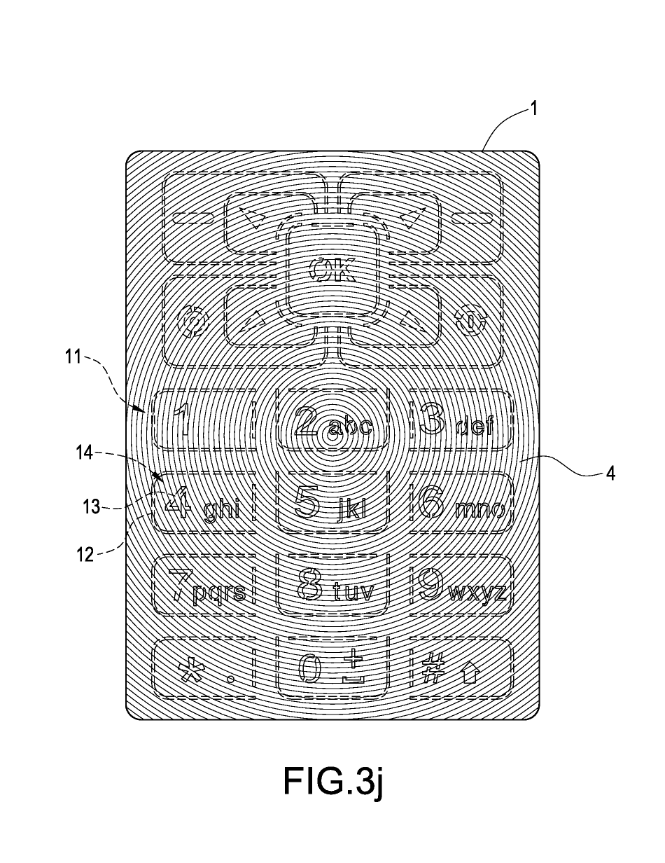

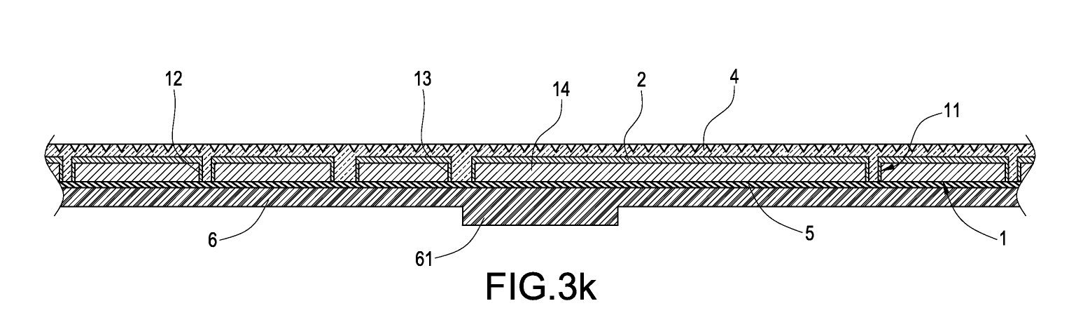

With reference to FIG. 2, it is a schematic view showing the procedure for manufacturing a metallic keypad of the present invention. As shown in this figure, the present invention provides a method for manufacturing a metallic keypad having a ripple luster. In manufacturing the metallic keypad (please also refer to FIG. 3), first, in a step 100, a metallic thin plate 10 is prepared as shown in FIG. 3(a). The metallic thin plate 10 is made of stainless steel (SUS) or Al—Mg alloy.

In a step 102, an etching process is performed. The metallic thin plate 10 is subjected to the etching process, so that the metallic thin plate 10 is formed thereon with a plurality of hollowed portions 11. The hollowed portions 11 are classified into line-type hollowed portions 12 and icon-type hollowed portions 13. The line-type hollowed portion 12 is used to define a pressing region of a keypad, and the icon hollowed portion 13 is set as an icon on the surface of the pressing region 14. As shown in FIG. 3(b), the icons includes numerals (0 to 9), characters (A to Z), special symbols (e.g., “#”, “*”, “.” dialing icon, ending icon and etc.), and navigational symbols.

In a step 104, a cutting process is performed. The etched metallic thin plate 10 having the hollowed portions 11 is cut to form a metallic keypad 1 having a predetermined shape, as shown in FIG. 3(c).

In a step 106, an electroplating process is performed. The completely cut metallic keypad 1 is electroplated in an electroplating tank, thereby forming an electroplated layer 2 on the surface of the metallic keypad 1 and the wall face of the hollowed portion 11, as shown in FIG. 3(d). According to the demand of a customer, the electroplated layer 2 can be processed to coat a layer of metallic such as nickel on the surface of the metallic keypad 1.

In a step 108, adhesion of a protective film is performed. After the electroplating process of the metallic keypad 1 is completed, as shown in FIG. 3(e), a layer of protective film 3 is adhered on the non-electroplated surface of the metallic keypad 1. Thereby, in subsequent processes, the non-electroplated surface of the metallic keypad 1 can be prevented from suffering contamination or damage.

In a step 110, the surface of the metallic keypad 1 is processed to generate a ripple luster. The metallic keypad 1 adhered with the protective film 3 is disposed in a mold 7. Then, a plastic material such as thermoplastic polyurethane (TPU) or thermoplastic elastomer (TPE) is injected into a cavity 71 of the mold 7, so that the plastic material (TPU or TPE) can be adhered on the surface of the electroplated layer 2 and the hollowed portion 11. At the same time, the pattern 72 on the inner surface of the cavity 71 of the mold 7 makes the plastic material (TPU or TPE) to form a pattern layer 4 as shown in FIGS. 3(f) to 3(j). The pattern layer 4 is a spinning having a ripple luster, straight lines or Archimedean screw. Further, the pattern layer 4 forms a protective layer for the metallic keypad 1.

In a step 112, an elastic layer is adhered on the metallic keypad 1. After the pattern layer 4 is made on the surface of the metallic keypad 1 completely, the protective film 3 on the other surface of the metallic keypad 1 is peeled off. Then, the non-electroplated surface of the metallic keypad 1 is coated with an adhesive layer 5. The elastic layer 6 having a plurality of protrusions 6 is adhered to the surface of the adhesive layer 5, so that the metallic keypad 1 and the elastic layer 6 are combined with each other, as shown in FIG. 3(k). Via the above steps, the manufactured of the metallic keypad 1 is completed. In the drawings, the elastic layer 6 is made of a rubber material.

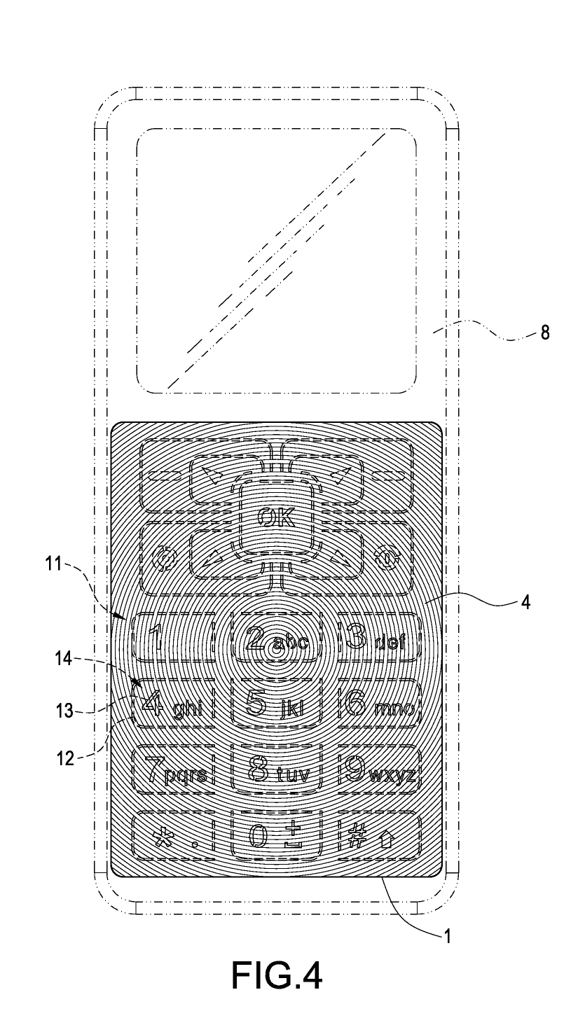

With reference to FIG. 4, it is a schematic view showing the metallic keypad of the present invention being used in a mobile phone. As shown in this figure, after the metallic keypad 1 of the present invention is manufactured completely, it can be applied to a mobile phone 8. When the external light illuminates the pattern layer 4 of the metallic keypad 1, the pattern layer 4 generates a reflective effect of a ripple luster, thereby increasing the aesthetic feeling of the mobile phone 8. Further, the pattern layer 4 can protect the surface of the metallic keypad 1 from suffering damage due to outside rigid objects.

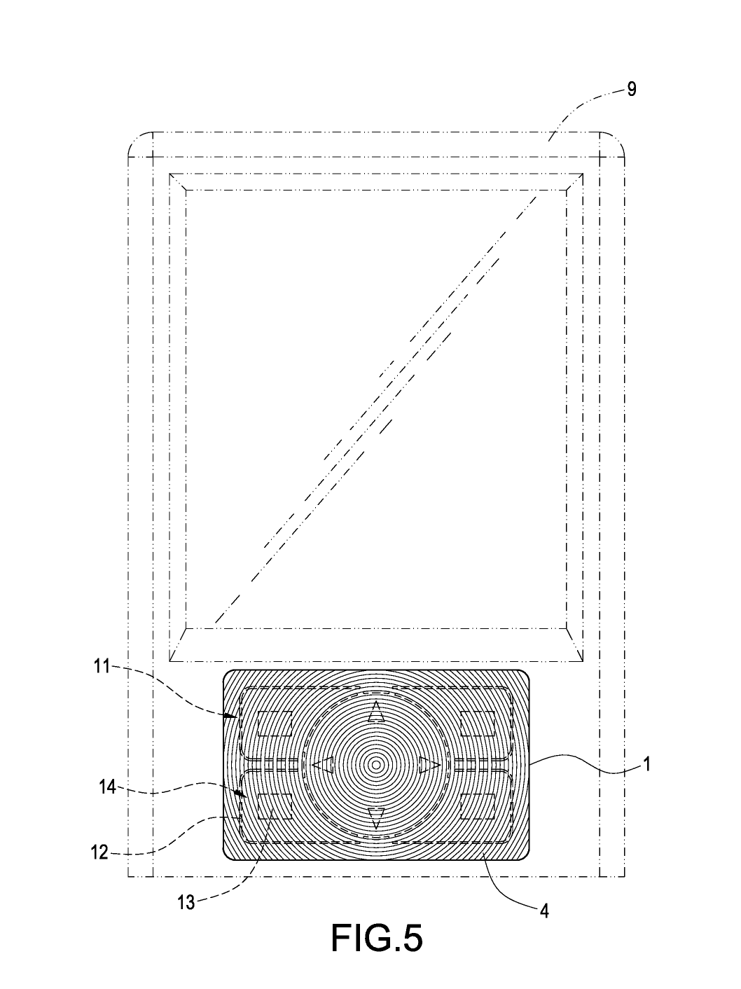

With reference to FIG. 5, it is a schematic view showing the metallic keypad of the present invention being used in a personal digital assistant (PDA). As shown in this figure, after the metallic keypad 1 of the present invention is manufactured completely, in addition to the mobile phone 8, it can be applied to a personal digital assistant (PDA) 9. When the light illuminates the pattern layer 4 of the metallic keypad 3, the pattern layer 4 generates a reflective effect of a ripple luster, thereby increasing the aesthetic feeling of the personal digital assistant (PDA) 9.

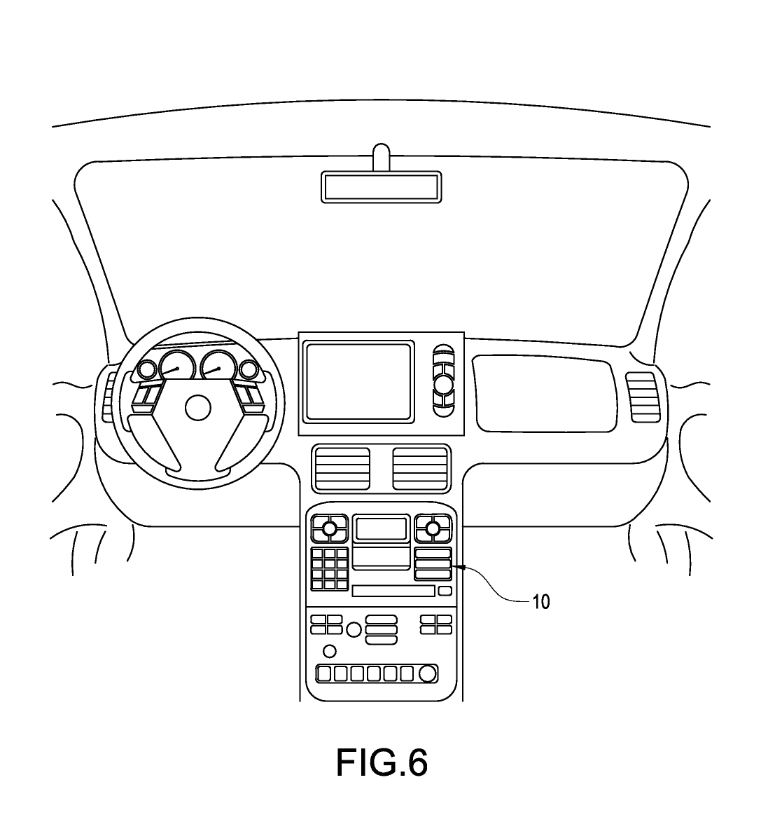

With reference to FIG. 6, it is a schematic view showing the metallic keypad of the present invention being used in an automobile stereo panel. As shown in this figure, in addition to the mobile phone 8 and the personal digital assistant (PDA) 9, the metallic keypad of the present invention can be mounted in an automobile stereo panel 10, thereby controlling the operations of an air conditioning system, audio-video system and satellite navigation system.

Further, the electroplated layer 2 can be made according to the demand of the customer. If the customer does not need the electroplated layer 2, the pattern layer 4 can be made directly on one side surface of the metallic keypad 1.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for manufacturing a metallic keypad having a ripple luster, the metallic keypad being arranged on a surface of an electronic device, the method comprising the steps of:
(a) preparing a metallic thin plate;
(b) etching the metallic thin plate so as to form a plurality of hollowed portions on the metallic thin plate;
(c) cutting the metallic thin plate so as to form a metallic keypad having a predetermined shape;
(d) disposing the metallic keypad into a mold; and
(e) injecting a plastic material into the mold so as to form a pattern layer.

2. The method according to claim 1, wherein the metallic keypad prepared in the step (a) is made of stainless steel (SUS) or Al—Mg alloy.

3. The method according to claim 1, wherein the hollowed portions formed in the step (b) comprise a line-type hollowed portion and an icon-type hollowed portion.

4. The method according to claim 3, wherein the line-type hollowed portion is defined as a pressing region of a key.

5. The method according to claim 3, wherein the icon-type hollowed portion is set as an icon of the surface of the pressing region.

6. The method according to claim 5, wherein the icons comprise numerals, characters, special symbols, and navigational symbols.

7. The method according to claim 1, wherein an electroplated layer is coated on the surface of the metallic keypad prior to the step (d).

8. The method according to claim 7, wherein the electroplated layer is made of a metallic material.

9. The method according to claim 1, wherein a layer of protective film is adhered on either surface of the metallic keypad prior to the step (d).

10. The method according to claim 1, wherein the plastic material set forth in the step (d) is adhered on the surface of the metallic keypad or the electroplated layer, so that the pattern on the inner surface of the mold makes the plastic material to form a pattern layer.

11. The method according to claim 10, wherein the pattern layer is any one of a spinning, straight lines or Archimedean screw.

12. The method according to claim 10, wherein the pattern layer forms a protective layer for the metallic keypad.

13. The method according to claim 10, wherein the plastic material is thermoplastic polyurethane (TPU) or thermoplastic elastomer (TPE).

14. The method according to claim 1, wherein an adhesive layer is applied on the other surface of the metallic keypad after the step (e), and then the elastic layer is adhered on the surface of the adhesive layer, thereby combining the metallic keypad with the elastic layer.

15. The method according to claim 14, wherein the elastic layer has a plurality of protrusions thereon.

16. The method according to claim 14, wherein the elastic layer is made of a rubber material.
